(19) United States
(12) Patent Application Publication
(10) Pub. No.: US 2026/0233416 A1
(43) Pub. Date: Aug. 13, 2026

(54) RETENTION DEVICE AND METHOD

(71) Applicant: FOREL S.P.A., Roncade (IT)

(72) Inventors: Fortunato VIANELLO, Roncade (IT); Riccardo VIANELLO, Roncade (IT)

(21) Appl. No.: 19/469,894

(22) PCT Filed: Mar. 29, 2024
(86) PCT No.: PCT/IT2024/050065

§ 371 Date: Sep. 26, 2025

(30) Foreign Application Priority Data
Mar. 29, 2023 (IT) 102023000006138

(51) Int. Cl. B25J 15/06; B65G 49/06

(52) U.S. Cl. CPC B25J 15/0616; B65G 49/061

(57) ABSTRACT

Retention device for retaining an object having at least one flat surface is provided, The retention device includes a sucker body provided with a suction channel and with a flexible holding lip defining an annular terminal part of said sucker body.

### CROSS-REFERENCE TO RELATED APPLICATION

The present application is a National Stage Application of PCT International Application No. PCT/IT2024/050065 filed on Mar. 29, 2024, which claims priority to Italian Patent Application 102023000006138, filed with the Italian Patent Office on Mar. 29, 2023, the disclosure of which is incorporated herein by reference in its entirety.

### FIELD OF THE INVENTION

The present invention concerns a retention device of the “sucker” type, used to retain, and subsequently move, objects that have at least one essentially smooth flat surface. The device finds particular application in the glass pane processing sector, where the sizes, and therefore weights, of the panes to be moved between one or several processing stations can be significant.

### BACKGROUND OF THE INVENTION

In the flat and curved glass production sector, and in the processes for working such glass, “sucker” type retention devices, hereafter referred to more simply as suckers, are widely used to facilitate the retention, movement and positioning of the objects being processed.

Suckers of various types are known, in terms of shape, construction material and use, which comprise an upper body in the shape of a cap that defines a chamber in which the vacuum is created, a suction duct communicating with the chamber for the creation of the vacuum, a lip that constitutes the terminal part of the sucker's body and which is the first to come into contact with the object to be retained.

The body usually has a metal core, generally aluminum, in order to withstand the stresses to which the sucker is subjected by the weight and inertia of the object to be retained. Generally, the external part of the body and the lip are made of the same material, which can be nitrile, silicone, isoprene, Viton®, polyurethane, etc.

The use of traditional suckers for retaining glass and other materials with a particularly glossy surface often causes the formation of traces and marks that are not easily visible under normal conditions, but are subsequently evident in particular light conditions, and very clearly visible if condensation forms on the surface where the sucker has acted.

The formation of the marks is explained by considering the morphology of the glass surface which, although it appears perfectly smooth, in reality at a microscopic level has a whole series of areas of roughness consisting of “peaks” and “troughs”. Small particles of dirt and also of material released by the suckers creep into the troughs of the glass surface when the sucker engages the glass and when it is removed.

These particles are so small in size that they are indistinguishable by the human eye under normal lighting conditions; however, they can modify the optical properties of the glass with the consequence that, in particular lighting conditions, the imprint of the typical sucker appears clearly visible. The surface wettability is also altered by these particles, so that small droplets of condensation behave differently in the zone where the sucker acted, unequivocally highlighting the typical mark.

To better understand the state of the art just described, it is useful to consider how the coupling and uncoupling of a sucker on the surface of a glass pane occurs.

With reference to FIG. 2a, the sucker 100, formed by sucker body 111, holding lip 114, suction duct 113, inserts 122, is located at a certain distance from the glass pane L. In this condition, it is not possible to induce the vacuum to make the sucker adhere to the glass pane.

In FIG. 2b, the holding lip 114 is in contact with the glass pane L and, if the air suction through the suction duct 113 were activated, the pressure inside the sucker 100 would decrease. At this point, the sucker 100 is pushed by the higher external pressure toward the glass pane L, creating the condition of FIG. 2c in which the sucker 100 has moved closer to the glass pane L and the holding lip 114 has travelled a sliding segment s on the surface of the glass pane L.

This process continues until the inserts 122 come into contact with the surface of the glass pane L, FIG. 2d.

It is now evident that the holding lip 114, in passing from the condition of FIG. 2b to the condition of FIG. 2d, has undergone a movement in which it slides on the surface of the glass pane L equal to an overall sliding segment s', accumulating any dirt particles that it may have encountered and releasing particles into the surface roughness of the glass pane L.

The sliding movement just described is what greatly aggravates the phenomenon, which remains contained in the zones of simple static contact, as occurs in correspondence with the inserts 122.

The fact that these particles are deposited in the “troughs” of the surface roughness explains why it is not possible to solve the problem with normal cleaning with various types of detergents. The removal of these particles can only occur through polishing with abrasive paste, that is, through the mechanical removal of the surface “peaks”, in order to therefore remove the material that has crept into the depths of the “troughs”.

It is useful to point out that if the phenomenon affects the entire area of the sucker, that is, both the zone of the external lip and also the internal zone where the stop inserts are present, the cause is mainly attributable to a lack of cleaning of the sucker itself. In fact, common practice shows that the usual, frequent and careful cleaning of the sucker with special solvents, such as isopropyl alcohol for example, is able to eliminate the appearance of the marks of the sucker caused by the simple static contact of the sucker's material with the glass.

Good cleaning practice, on the other hand, is not able to solve the phenomenon of the appearance of the mark as a circle in correspondence with the sucker's lip, precisely because it is the consequence of the sliding movements of the sucker's material against the glass.

It is clear that the material that the sucker, and in particular the holding lip, is made of, in addition to guaranteeing the hold with the glass surface, has to also be able to withstand a considerable elastic deformation in order to pass from the resting condition (FIG. 2a) to the working condition (FIG. 2d). For this reason, the materials that the sucker is made of are those already indicated above, despite the fact they are easily subject to releasing particles and to wear by rubbing against the glass.

In a first known solution, the sucker for retaining the glass is covered with a special textile material, so as to prevent the sucker's material from coming into contact with the glass. These protections, commonly referred to as “cover” or “covers”, are widely used in the flat glass processing sector, although they have some disadvantages. The first of these is a significant reduction in the suckers' performance, caused, first of all, by the non-optimal seal of the cover's material, with a consequent reduction of the degree of vacuum inside the sucker, but most importantly, and specifically if the sucker is used for transport, that is, it is subjected to stresses that are parallel to the glass surface, by the reduced friction coefficient of the material of the protection in respect to the common materials used for the suckers. All of this leads to the need to use larger suckers and/or increase their number. Another disadvantage of cover protectors is the need to replace them daily, or even more frequently, due to the premature deterioration of the material which they are made of.

Another known solution proposes a fabric cover for the sucker's lip, leaving the central part of the sucker free. In this way, however, there remains a rubbing of the fabric cover with the surface of the glass, since the protection is integral with the sucker's lip. This does not eliminate the risk of particles being released onto the surface of the glass, or the movement of dirt particles already present on the glass toward the surface's “troughs”. Furthermore, since the lip cover is made of air permeable fabric, a certain decrease in the vacuum inside the sucker has to be considered.

Another known solution describes a silicone protection installed around the sucker's lip that separates it from the surface of the glass which, while solving the problem of the vacuum reduction, leaves the limitations of the previous solution unchanged.

Document U.S. Pat. No. 6,425,565 B1 describes a sucker for retaining and moving objects, in particular objects having a flexible surface, such as lithographic or printing plates. The sucker is provided with a flexible sheet that serves as a barrier between the sucker's contact flange and the object to be retained and handled. In this document, because of how it is sized and structured, the flexible sheet hinders a strong adhesion to the object. This limits the use of this sucker in applications that provide to handle only light and delicate objects.

There is therefore the need to perfect a retention device and method, in particular for glass panes, but not only, in order to overcome at least one of the disadvantages of the state of the art.

One purpose of the present invention, which corresponds to the technical problem that the Applicant intends to solve, is to provide a device and perfect a corresponding method for retaining an object having at least one smooth flat surface, for example a glass pane, eliminating or at least significantly reducing the phenomenon of surface marks caused by contact with the sucker, without significantly affecting its performance, that is, preserving its load capacity especially in a direction parallel to the surface of the object to be retained.

Another purpose of the present invention is to provide a retention device that is simple to make, economical and does not require frequent replacements or interventions for its maintenance, thus guaranteeing continuity of the production flow.

Another purpose of the present invention is to provide a retention device that can be cleaned easily and quickly.

The Applicant has devised, tested and embodied the present invention to overcome the shortcomings of the state of the art and to obtain these and other purposes and advantages.

### SUMMARY OF THE INVENTION

The present invention is set forth and characterized in the independent claims. The dependent claims describe other characteristics of the present invention or variants to the main inventive idea.

In accordance with the above purposes and to resolve the technical problem disclosed above in a new and original way, also achieving considerable advantages compared to the state of the prior art, a retention device according to the present invention for retaining an object having at least one preferably smooth flat surface comprises a sucker body provided with a suction channel and with a flexible holding lip defining an annular terminal part of the sucker body.

In accordance with one aspect of the present invention, the retention device comprises a protection element associated with the sucker body and configured to annularly house, at least partly, the holding lip in a sliding manner, being interposed between the latter and the flat surface.

Doing so avoids the sliding contact between the holding lip and the flat surface of the object to be retained, and therefore the formation of traces and marks. The protection element, once in contact with the object to be retained, remains in a fixed position, that is, it does not slide or slip, configuring a contact that is only of a static type, while the holding lip, which is flexible, can slide inside the protection element. In fact, the holding lip is not integral with the protection element since it can extend, or deform, inside it.

In accordance with another aspect of the present invention, the protection element is inserted only around the holding lip. This condition allows to improve the adhesion of the sucker to the object to be retained. This proves to be particularly advantageous when it is necessary to support heavy objects such as glass panes, for example.

In accordance with another aspect of the present invention, the protection element is inserted in a removable manner around the holding lip.

In accordance with another aspect of the present invention, the protection element essentially has a shape that corresponds to that of the perimeter profile of the holding lip. In one embodiment of the present invention, the holding element is a ring. According to possible embodiments, the holding element is a ring which can have a circular, oval or polygonal shape.

In accordance with another aspect of the present invention, the protection element has a lateral wall bent at an angle, defining an annular pocket able to at least partly house the holding lip.

In accordance with another aspect of the present invention, the pocket has a predefined conformation, independent of a transverse position of the holding lip. In other words, the pocket has a rigid conformation that does not adapt to the holding lip when the latter deforms, during the operation of the device.

In accordance with another aspect of the present invention, the lateral wall is formed by an oblique portion and by a flat portion which is formed by an annular plate.

In accordance with another aspect of the present invention, the flat portion is positioned externally with respect to the overall dimensions of a central part of the sucker body where the suction channel is created.

In accordance with another aspect of the present invention, a central zone of the flat portion has a free central area slightly smaller than an area of a bottom wall of the sucker body which faces, during use, the flat surface of the object.

In accordance with another aspect of the present invention, a ratio between the area of the bottom wall and the free central area is comprised between about 1.1 and about 1.3. In accordance with another aspect of the present invention, the lateral wall has an internal radial size smaller than an external radial size of the holding lip. In this way, the holding lip keeps the protection element in position without the need for specific coupling means.

In accordance with another aspect of the present invention, the protection element is made of a compact material, without voids. This allows to reduce the loss of vacuum during the operation of the retention device to a minimum.

In accordance with another aspect of the present invention, the protection element is made of a thermoplastic or thermosetting material.

Some embodiments of the present invention concern a method for retaining an object having at least one flat surface, comprising the steps of:
making available a sucker body provided with a suction channel and with a flexible holding lip defining an annular terminal part of the sucker body;
associating with the sucker body a protection element for at least partly housing, annularly and in a sliding manner, the holding lip, defining the retention device;
moving the retention device closer, until the protection element is taken into contact with the flat surface;
generating a vacuum condition between the sucker body and the object by means of suction means fluidically connected to the suction channel.

### BRIEF DESCRIPTION OF THE DRAWINGS

These and other aspects, characteristics and advantages of the present invention will become apparent from the following description of an embodiment, given as a non-restrictive example with reference to the attached drawings wherein:

FIGS. 1a and 1b show a schematic section view of a retention device according to the present invention in a resting condition (FIG. 1a) and in working condition (FIG. 1b);

FIGS. 2a-2d show a schematic sequence of operation of a retention device of the state of the art.

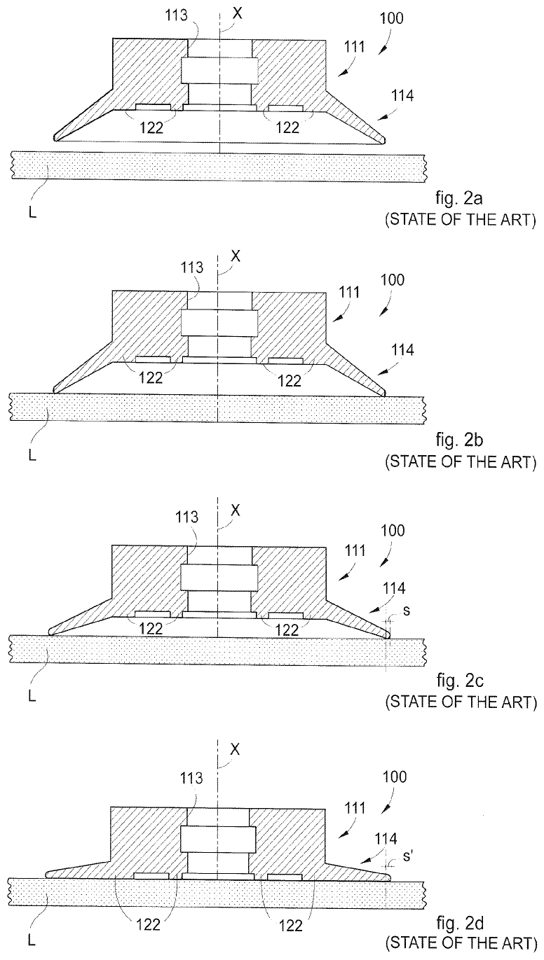

We must clarify that the phraseology and terminology used in the present description, as well as the figures in the attached drawings also in relation as to how described, have the sole function of better illustrating and explaining the present invention, their purpose being to provide a non-limiting example of the invention itself, since the scope of protection is defined by the claims.

To facilitate comprehension, the same reference numbers have been used, where possible, to identify identical common elements in the drawings. It is understood that elements and characteristics of one embodiment can be conveniently combined or incorporated into other embodiments without further clarifications.

### DESCRIPTION OF AN EMBODIMENT OF THE PRESENT INVENTION

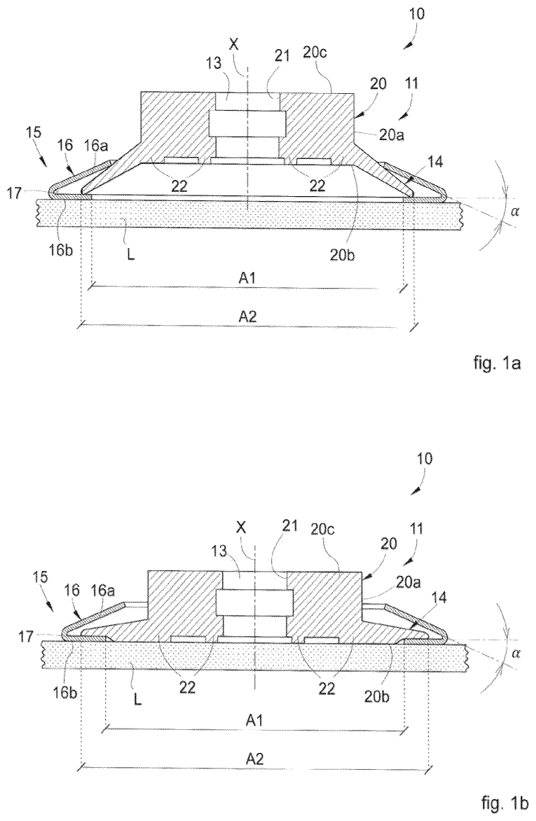

With reference to FIGS. 1a-1b, a retention device 10 according to the present invention for retaining, and subsequently moving, an object having at least one essentially smooth flat surface, for example a glass pane L, comprises a sucker body 11 provided with a suction duct 13, open toward the outside, in the direction of the object to be retained, and with a flexible holding lip 14 defining an annular terminal portion of the sucker body 11.

The retention device 10 comprises, or is associated with, suction means (not shown) fluidically connected to the suction duct 13 to generate a vacuum in a gripping zone defined by the holding lip 14.

The retention device 10 according to the invention comprises a protection element 15 annularly associated with the sucker body 11 and configured to house the holding lip 14 in a sliding manner, being interposed between the latter and the glass pane L.

In other words, the loose coupling between the holding lip 14 and the protection element 15 allows a relative movement between them, in particular a relative movement between the holding lip 14 (elastically deformable part) and the protection element 15 (part that remains fixed).

The term “annular” and its derivatives do not necessarily mean a circular profile, but any perimetrically closed and centrally open profile whatsoever, which can have a circular, oval, polygonal shape, etc.

The protection element 15 essentially has a shape that corresponds to that of the perimeter profile of the holding lip 14. Therefore, if the holding lip 14 is circular, the protection element 15 is also circular. In the embodiments of FIGS. 1a, 1b the protection element 15 is a protection ring, or collar.

The annular shape of the protection element 15 allows, as will be clearer in the following description, both to prevent the holding lip 14 from coming into direct contact with the pane L avoiding the formation of marks, and also to preserve the load capacity of the retention device 10, especially in a direction parallel to the surface of the pane L to be retained, and possibly moved, since no physical obstacle that could reduce the gripping effect is interposed between the suction duct 13 and the glass pane L.

The sucker body 11 comprises a central part 20 in which the suction duct 13 is defined, made through, which develops around a central axis X of the sucker body 11 between an upper wall 20c and a bottom wall 20b.

The central part 20 can have a cylindrical shape, for example. However, the person of skill in the art will understand that the shape of the central part 20 is not limited to the circular one shown in FIGS. 1a-1b.

The holding lip 14 extends around the central part 20 in a direction that moves transversely away from the central axis X. The transverse extension of the holding lip 14 is larger than a transverse extension of the central part 20.

The holding lip 14 essentially consists of a flexible, that is, elastically deformable, annular wall. The flexible annular wall can have a section that narrows as it moves away from the central axis X, that is, from the central part 20.

The holding lip 14 extends from a lateral wall 20a of the central part 20 in correspondence with the bottom wall 20b, of which it defines a continuity.

According to the present invention, the protection element 15 is removably inserted around the holding lip 14. The protection element 15, by exploiting the elasticity of the material of the holding lip 14, can be easily inserted (extracted) around the latter with a movement of insertion (extraction) along the central axis X.

The shape and sizes of the protection element 15 are such as to house the holding lip 14 in a sliding manner, in all the operating conditions of the retention device 10.

The protection element 15 has a lateral wall 16 bent at an angle, defining an annular pocket 17 able to at least partly house the holding lip 14.

The wall 16 can be bent at an angle with angular value a comprised between about 10° and about 20°, for example about 15°.

The pocket 17 has a predefined conformation, independent of a transverse position of the holding lip 14.

In other words, the pocket 17 maintains its shape in any operating condition of the retention device 10, while the holding lip 14 can deform elastically inside the pocket 17. Therefore, when the holding lip 14 bends so that it flattens parallel to the flat surface of the glass pane L, the pocket 17 does not undergo any deformation, at least macroscopic.

The pocket 17 is open in the direction of the central axis X to allow the insertion of the holding lip 14 that can slide inside it. During the passage from the resting condition to the working condition, the sliding contact takes place between the holding lip 14 and the protection element 15 while the protection element 15 is in static contact with the glass pane L.

The lateral wall 16 has an internal radial size smaller than an external radial size of the holding lip 14. In this way, even in a resting condition of the retention device 10, the protection element 15 is sustained, essentially by interference, by the holding lip 14.

The lateral wall 16 is formed by an oblique portion 16a, inclined at an angle of less than 90° with respect to the central axis X, and by a flat portion 16b essentially orthogonal to the central axis X.

The oblique portion 16a is located above the flat portion 16b and has an inclination such as to determine an interference with the holding lip 14.

The flat portion 16b defines an annular plate configured to come into contact with the glass pane L and to essentially prevent the sliding contact between the holding lip 14 and the glass pane L when the retention device 10 is taken into a working condition.

The flat portion 16b, being annular, leaves a central zone thereof completely open. Therefore, the bottom wall 20b of the central part 20 of the sucker body 11 faces the glass pane L directly. Therefore, the suction duct 13 does not encounter physical obstacles before the glass pane L, and the grip on the glass pane L is always optimal.

The central zone of the flat portion 16b can have a free central area A1 slightly smaller than an area A2 of the bottom wall 20b. In FIGS. 1a, 1b these areas are represented as a linear extension in lateral view. This implies that the central zone of the flat portion 16b is almost completely open, offering the bottom wall 20b the possibility to act with almost all of its useful surface against the flat surface of the object to be retained.

A ratio between the area A2 of the bottom wall 20b and the free central area A1 can be comprised between about 1.1 and about 1.3.

The glass pane L, thanks to the presence of the protection element 15, receives only the static contact of the protection element 15 and of the bottom wall 20b, both not generating any sliding during the coupling steps because they approach the glass pane L essentially in the axial direction. The only transverse movement is that of the holding lip 14 which, however, takes place inside the pocket 17 and not against the glass pane L.

The protection element 15 is made of compact material, free of “voids”. In other words, the protection element 15 is made of an air-impermeable material and thus able to reduce the loss of vacuum during the operation of the retention device 10 to a minimum.

The protection element 15 is made of a plastic material that does not release particles following rubbing during contact with the glass pane L.

The protection element 15 can be made of a thermoplastic or thermosetting material.

The thermoplastic material can be chosen from a group comprising polyethylene (PE), polypropylene (PP), polyethylene terephthalate (PET), polyester (PS), polyvinylchloride (PVC), polymethylmethacrylate (PMMA), polycarbonate (PC), acrylonitrile butadiene styrene (ABS), polyamide (PA), polylactide (PLA), etc.

The thermosetting material can be chosen from a group comprising polyester resins, phenolic resins, epoxy resins, etc.

The retention device 10 can also comprise one or more inserts 22 associated with, or forming part of, the sucker body 11.

The inserts 22 can be made on, or associated with, the bottom wall 20b of the sucker body 11.

The operation of the retention device 10 described heretofore, which corresponds to the method according to the present invention, comprises the following steps:
making available a sucker body 11 provided with a suction channel 13 and with a flexible holding lip 14 defining an annular terminal part of the sucker body 11;
associating the protection element 15 with the sucker body 11 to annularly house the holding lip 14;
moving the retention device 10 thus made closer, until the protection element 15 is taken into contact with the flat surface of the glass pane L;
generating a vacuum condition between the glass pane L and the holding lip 14 by means of suction means fluidically connected to the suction channel 13.

In particular, once the retention device 10 has been assembled and taken into contact with the glass pane L as previously described, the retention device 10 operates between a resting condition and a working condition.

In the resting condition, the holding lip 14 is inclined with respect to the central axis X and the suction of air through the suction duct 13 is not active.

In the working condition, the suction of air through the suction duct 13 is activated and the holding lip 14, which is located inside the pocket 17, elastically deforms inside the pocket 17, flattening parallel to the flat surface of the glass pane L. During the deformation of the holding lip 14, the protection element 15 remains stationary with respect to the flat surface of the glass pane L.

During the working condition, the lower wall 20b of the central part 20 of the sucker body 11 comes into direct contact with the glass pane L, without there being any obstacle or barrier.

It is clear that modifications and/or additions of parts may be made to the retention device 10 and method as described heretofore, without departing from the field and scope of the present invention, as defined by the claims.

It is also clear that, although the present invention has been described with reference to some specific examples, a person of skill in the art will be able to achieve other equivalent forms of a retention device and corresponding method, having the characteristics as set forth in the claims and hence all coming within the field of protection defined thereby.

In the following claims, the sole purpose of the references in brackets is to facilitate their reading and they must not be considered as restrictive factors with regard to the field of protection defined by the claims.

1. A retention device for retaining an object having at least one flat surface, comprising a sucker body provided with a suction channel and with a flexible holding lip defining an annular terminal part of said sucker body, comprising a protection element configured to annularly house, at least partly, said holding lip in a sliding manner, being interposed between the latter and said flat surface, and wherein said protection element is inserted only around said holding lip.

2. The retention device of claim 1, wherein, said protection element is inserted in a removable manner around said holding lip.

3. The retention device of claim 1, wherein said protection element has a lateral wall bent at an angle, defining an annular pocket able to at least partly house said holding lip.

4. The retention device of claim 3, wherein said pocket has a predefined conformation, independent of a transverse position of said holding lip.

5. The retention device of claim 3, wherein said lateral wall is formed by an oblique portion and by a flat portion which is formed by an annular plate.

6. The retention device of claim 5, wherein said flat portion is positioned externally with respect to the overall dimensions of a central part of said sucker body where said suction channel is provided.

7. The retention device of claim 5, wherein a central zone of the flat portion has a free central area slightly smaller than an area of a bottom wall of said sucker body which faces, during use, said flat surface of said object.

8. The retention device of claim 7, wherein a ratio between the area of the bottom wall and said free central area is comprised between 1.1 and 1.3.

9. The retention device of claim 3, wherein said lateral wall has an internal radial size smaller than an external radial size of said holding lip.

10. The retention device of claim 1, wherein said protection element is made of a compact material, without voids.

11. The retention device of claim 1, wherein said protection element is made of a thermoplastic or thermosetting material.

12. The retention device of claim 1, wherein it comprises one or more inserts associated with, or forming part of, the sucker body.

13. A method for retaining an object having at least one flat surface, comprising the steps of:
making available a sucker body provided with a suction channel and with a flexible holding lip defining an annular terminal part of said sucker body;
associating a protection element for annularly housing, at least partly, said holding lip defining a retention device;
moving said retention device closer, until said protection element is taken into contact with said flat surface;
generating a vacuum condition between said sucker body and said object by means of suction means fluidically connected to said suction channel.
